(19) United States
(12) Patent Application Publication
(10) Pub. No.: US 2019/0340692 A1
(43) Pub. Date: Nov. 7, 2019

(54) SYSTEMS AND METHODS FOR AUTOMATING PROPERTY DAMAGE EVENT RESPONSE WORKFLOW

(71) Applicant: ACCURENCE, INC., Louisville, CO (US)

(72) Inventors: Jacob Labrie, Broomfield, CO (US); Timothy Bruffey, Commerce City, CO (US)

(21) Appl. No.: 15/970,484

(22) Filed: May 3, 2018

(51) Int. Cl. G06Q 40/08; G06Q 10/06; G06Q 30/00; G06Q 10/10

(52) U.S. Cl. CPC G06Q 40/08; G06Q 10/063112; G06Q 30/01; G06Q 30/018; G06Q 10/103; G06Q 10/063118

(57) ABSTRACT

Provided is a method and system for automating emergency event response. Information associated with an event is received via a network connection. An extent of impact of the event is determined. A location of the impact of the event is determined. One or more geographical zones associated with the event are determined based on the determination of the extent of impact and the determination of the location of the impact. Each of the geographical zones is associated with a different section portion of the geographical area. A first physical property of one or more physical properties is determined to qualify for contractor inspection based on a location of each of one or more physical properties and a determined access level for geographical zone relative to the location. A customer inspection work flow associated with the first physical property is transmitted to a user device associated with a contractor.

### CROSS-REFERENCE TO RELATED APPLICATIONS

### Technical Field

The present disclosure is directed generally toward building damage inspection systems and methods and more particularly toward automating systems and methods for inspection and analysis of damage to building structures.

### Background

Homes and commercial buildings may experience damage or otherwise be negatively impacted due to fires, earthquakes, tornados, flooding, and other disasters. Such disasters may be of natural causes, or they may result from mechanical failure, human error, or any number of other non-natural causes. As an example, flooding may result from a wide variety of natural conditions, including excessive rain, storm surges, or rapid melting of snow or ice. Additionally, freezing temperatures may cause the water inside water pipes to freeze, expand and burst the pipes. Water hoses may be become disconnected, or may become brittle and break. Sinks and commodes may overflow from clogged pipes. As another example, fire can result from natural causes, such as lightning strikes, or it can result from human-related causes, such as a gas leak resulting in gas buildup, ignition and “puff back”; a stove or oven that becomes excessively hot; an overloaded electrical circuit; or a curling iron left in close proximity to a flammable material. The cause of damage to property may come from any number of sources and the damage caused to the property typically varies greatly with each and every cause in any number of ways related to the scope and magnitude of the damage.

The damage caused by water, fire, hail or other disasters is rarely easy to identify, or even limited to the area where the mishap occurred. For example, hail may damage a roof in places which are difficult to view and/or access. As a second example, a pipe may suffer a break that is confined to a particular location, but broken pipes often lead to flooding, which may be widespread throughout an entire structure and the scope of such flooding may be impossible to determine during simple inspection. Likewise, even though a fire may be contained to a particular room or location in a building, it may cause smoke damage throughout the entire building or even adjacent buildings in places not easily accessible. Moreover, the building may suffer water damage and/or other types of damage as a result of efforts to extinguish the fire. Such damage may affect the structure of a property in ways that are impossible to determine without extensive testing or, in some cases, actual demolition of the property.

When a damaged structure is insured, the first step in disaster mitigation and restoration often involves notifying the insurance company of the damage or loss. The insurance company then typically dispatches a person, e.g. a vendor or adjuster, to physically and personally visit the damaged location to assess the loss and write an initial mitigation estimate that addresses the initial loss and any secondary damages. Alternatively, the insured party may call a vendor directly, personally provide a description of the damage to receive an initial mitigation estimate from the vendor, and then contact the insurance company.

Methods of inspecting roof damage typically also require physical presence of an analyst on or near the damaged building. Such methods limit the analysis to buildings which the analyst or inspection company has obtained permission to inspect. In many cases, however, damage caused by nature, e.g. hail or high-winds, is widespread and far-reaching across city blocks, neighborhoods, towns and counties. For an insurance or inspection company to obtain permission to physically access each and every damaged property after a storm may require an exhausting, time-consuming and expensive process.

Also, an owner of a damaged property or an insurance company may need estimates from a number of repair companies in order to generate an estimate of damage to the property. Each repair company, in order to supply its own estimate or bid for cost of repairing the property may need its own analyst to physically visit the property. As such, one estimate to one damaged property may require a multitude of analysts from different repair companies each visiting and analyzing the property. In the case of widespread damage across even one neighborhood after a storm a proper analysis of the damage would require an enormously time-consuming and expensive process before an estimate can be generated. These expenses and time delays add up and add a great deal of economic waste with each individual property damaged.

The cost in money and time of inspecting damaged properties and creating estimates has a massive effect on the overall efficiency of repairing damaged properties. To reduce such cost, insurance companies employ drones, use computer models to simulate properties indoors and outdoors, and employ low-level inspectors. Such approaches, however, do not cure the efficiencies with the process from the time of the damage occurring to the moment the estimating process begins.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a network in accordance with embodiments described herein;

FIG. 2 is a block diagram of a computer system in accordance with embodiments described herein;

FIG. 3 is an illustration of a geographical location including physical property structures separated into zones;

FIG. 4 is an illustration of a guideline management work flow user interface;

FIG. 5 is a flowchart illustrating an exemplary method in accordance with embodiments described herein;

FIG. 6 is a flowchart illustrating an exemplary method in accordance with embodiments described herein;

FIG. 7 is a flowchart illustrating an exemplary method in accordance with embodiments described herein;

FIG. 8 is a flowchart illustrating an exemplary method in accordance with embodiments described herein; and

FIG. 9 is a flowchart illustrating an exemplary method in accordance with embodiments described herein.

### DETAILED DESCRIPTION

It is with respect to the issues and other problems presently faced by those of skill in the relevant art and described above that the embodiments presented herein are contemplated. What is needed is systems and methods of improving efficiencies related to the selection of inspectors and related to the following of rules and guidelines set by insurance companies.

When a severe weather event occurs, a possibility exists in which an extreme number of properties may be damaged. In such an event, there may be a large number of different inspectors prepared to analyze the damage of each property. The need for an efficient process in managing the work of the inspectors leading from the time of the severe weather event to the creation of estimates for the repair to each property is increasingly important.

When a massive disaster occurs, such as a hurricane, tsunami, earthquake, flood, tornado, etc. the many damaged properties across a large geographical area may be separated into particular zones. The zones may be based on zip codes, or radii from an epicenter of the damage.

Different areas, such as municipalities, counties, states, etc. may have different guidelines for handling these types of situations. Zones may be adjusted to coincide with such areas, such that within each zone the same guidelines may be applicable.

Each damaged property may have a different insurance policy and/or be insured a different insurance company. Each insurance company may have different rules and guidelines associated repairs to a damaged property. Such rules and guidelines may vary further with each insurance policy.

Following a natural disaster or other type of emergency situation, when many properties are damaged across a large area, many inspectors may dispatch across the area. Each inspector may create a first scope of repair before being enabled to create a more thorough estimate of the damage.

Increasing the efficiencies of the process of receiving scopes of repair, selecting a contractor, and ensuring the contractor follows proper rules and guidelines in the creation of the estimate and the completion of the repairs is a critical step in improving the overall process of repairing damaged properties after a disaster.

What is needed is methods and systems for managing guidelines and enabling efficient and at least partially automated guideline management as well as methods and systems for guiding the inspection of damaged properties such that repair scopes may be accurately and efficiently generated and accurate and proper prices can be applied in the generation of an estimate associated with the repair of the damaged properties.

The guideline management system may be capable of ensuring that such a scope of repair is in compliance with unique guidelines. Unique guidelines may be configured by a company or other user of the guideline management system. Unique guidelines may require particular inspection documentation. The guideline management system may support and assist the inspector through the process of creating, updating, and completing such inspection documentation in compliance with any and all applicable guidelines.

Following the generation of an estimate, an inspector may or may not have access permissions to make a change to the estimate. In some embodiments, an inspector must be first authorized before any determination as to whether the inspector may have such access. In some embodiments, such access may depend on the configuration of the customer's guideline engine.

In some embodiments, in the event that a contractor does have access the guideline management system, the contractor may be enabled to analyze a draft of the estimate and may compare the draft of the estimate with audit guidelines as well as the original inspection inputs. In this way, the contractor may be capable of identifying possible violations, areas requiring additional documentation, or outright violations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Hereinafter, “in communication” shall mean any electrical connection, whether wireless or wired, that allows two or more systems, components, modules, devices, etc. to exchange data, signals, or other information using any protocol or format.

The terms “determine,” “calculate,” and “compute,” and variations thereof, as used herein, are used interchangeably and include any type of methodology, process, mathematical operation or technique.

The ensuing description provides embodiments only and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

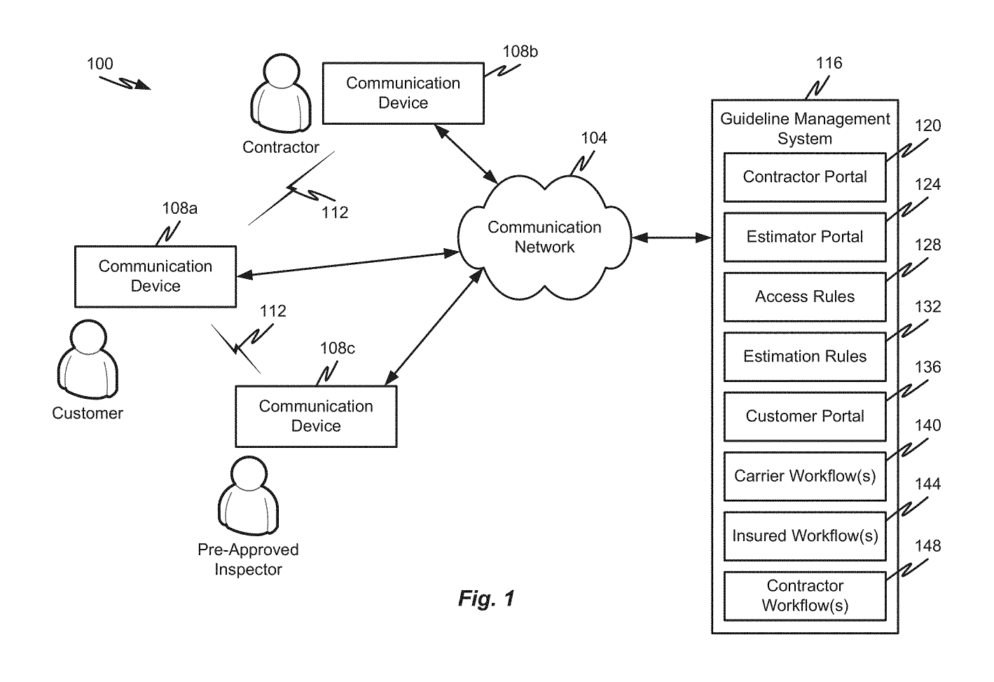

Embodiments of the present disclosure may be better understood with reference to FIGS. 1-9. Referring first to FIG. 1, an illustrative network-based system 100 will be described in accordance with at least some embodiments of the present disclosure. The network-based system 100 of FIG. 1 may be a distributed system and, in some embodiments, comprises a communication network 104 connecting one or more communication devices 108a-c (e.g. smartphones, computers, laptops, etc.) to a guideline management system 116.

In some embodiments, the network-based system 100 may include one or more communication devices 108a-c. A communication device 108a-c may be in some embodiments comprise a smartphone comprising a handheld still image and/or video camera. In some embodiments, the communication device 108a-c may be a smartphone or tablet or some other personal computing device with a camera. In some embodiments, the communication device 108a-c may be controlled and operated by a human operator either directly and/or physically.

The one or more communication devices 108a-c may be capable of transmitting information to and from other communication devices 108a-c via communication channels 112. Communication channels 112 may comprise one or more of Bluetooth™, WIFI, a cellular network, etc.

Each of the one or more communication devices 108a-c may be operated by one or more users. Users may be one or more of a contractor, inspector, customer, insurance adjuster, guideline management system operator, etc.

Data input into a communication device 108a-c may be transmitted and/or live-streamed to the guideline management system 116 via the network 104 The guideline management system 116 may automatically store the received data so that it may be easily retrieved at a later time for further processing and/or analysis. The data may be tagged by the guideline management system 116 with identifying information or may be tagged by the collecting device prior to transmission. Data collected or stored locally may be uploaded in bulk or in portions to the guideline management system 116 via the network 104. The data may be uploaded via the network 104 automatically or upon command from a user operator.

Data collected by the one or more communication devices 108a-c may be sent to the guideline management system 116 via the network 104. The data may be sent or transmitted via a wireless network e.g. an LTE or other high-speed wireless communication network or via a wireless internet, e.g. WIFI, connection, or by wired connection, e.g. Ethernet or cable.

The guideline management system 116 may be in the control of an insurance company or may be accessible by a number of insurance companies or automated settlement engine operators. The guideline management system 116 may comprise one or more application programming interfaces (APIs), client interfaces, and/or instruction sets.

The components of the guideline management system 116 may comprise one or more of a customer portal 136, a contractor portal 120, an estimator portal 124, and/or portals for other types of users or user groups. The customer portal 136 may comprise an application accessible by communication devices 108a operated by one or more insurance customers. Insurance customers may be owners of insured properties. The customer portal 136 may allow for customers to input data into the guideline management system 116 via a communication device 108a.

The contractor portal 120 may comprise an application accessible by communication devices 108b operated by one or more contractors. Contractors may be capable of making repairs to insured properties. The contractor portal 120 may allow for contractors to input data into the guideline management system 116 via a communication device 108b.

The estimator portal 124 may comprise an application accessible by communication devices 108c operated by one or more inspectors. Inspectors may be capable of inspecting damaged properties and have permissions associated therewith. The estimator portal 124 may allow for inspectors to input data into the guideline management system 116 via a communication device 108c.

The guideline management system 116 may comprise one or more database interfaces controlling access to databases of rules. An estimation rules database 132 may comprise information related to rules and guidelines which may need to be followed by inspectors in the inspection of damaged properties. The rules and guidelines in the estimation rules database 132 may be associated with one or more of insurance company policies, state, federal, or municipality rules, or any other rules, policies, or guidelines which may affect the policies in force for any given property.

An access rules database 128 may comprise rules and guidelines related to the qualities required for a particular inspector to inspect a particular type of property. The access rules in the access rules database 128 may comprise rules relating to limits on distances between inspectors and damaged properties, rules relating to licenses required for properties within certain areas or properties with certain qualities. The access rules in the access rules database 128 may be related to the determination as to whether an inspector may be approved to make an estimate and/or scope of repair related to a particular damaged property.

The guideline management system 116 may comprise one or more workflow databases. Workflow databases of the guideline management system 116 may comprise an insurance carrier workflow 140. The insurance carrier workflow 140 may comprise one or more workflow instruction sets. Such workflow instruction sets may be related to particular guidelines set in place by a particular insurance carrier, governments and/or regulatory institutions and related to the selection of property inspectors and contractors.

Workflow databases of the guideline management system 116 may comprise an insured property/customer workflow 144. The insured property/customer workflow 140 may comprise one or more workflow instruction sets. Such workflow instruction sets may be related to particular guidelines set in place by a particular insurance carrier governments and/or regulatory institutions and related to collecting information from an insured property owner related to damage to the insured property. For example, an insured property/customer workflow 140 may comprise instructions to be provided to a customer using a communication device 108a in the generation of a first notice of loss and the transmission of such a notice to the guideline management system.

Workflow databases of the guideline management system 116 may comprise a contractor workflow 148. The contractor workflow 140 may comprise one or more workflow instruction sets. Such workflow instruction sets may be related to particular guidelines set in place by a particular insurance carrier, governments and/or regulatory institutions and related to guiding an inspector through the process of inspecting a damaged property in accordance with any and all applicable policies in force for the particular damaged property, thus ensuring the resulting inspection will include any and all required information to generate a proper scope of repair for the property.

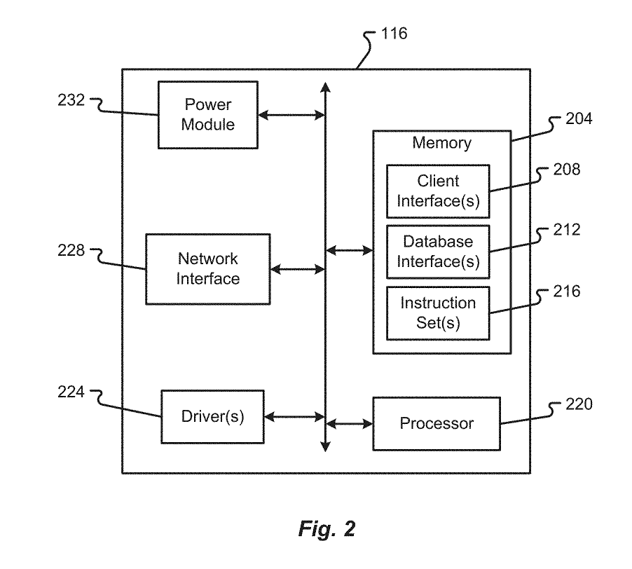

As illustrated in FIG. 2, the guideline management system 116 may comprise a power module 232, a network interface 228, one or more drivers 224, one or more processors 220, and/or a memory device 204.

The processor 220 of the guideline management system 116 may be capable of executing one or more of the methods and systems discussed herein. The processor 220 may be capable of receiving and transmitting information to and from communication devices 108a-c as well as other network locations via the network interface 228. Methods described herein may be in the form of software and may operate in conjunction with one or more of the drivers 224.

The memory 204 of the guideline management system 116 may store information related to the elements of the guideline management system 116 discussed above. The memory may section such information into databases such as one or more client interfaces 208, one or more database interfaces 212, and/or one or more instruction sets 216.

In some embodiments, the elements of the guideline management system 116 may be implemented in a common entity such as a server and may reside in a common enterprise network (e.g., behind a common firewall). In other embodiments, the guideline management system 116 may be implemented by different entities and/or at different enterprise networks. In some embodiments, the guideline management system 116 may be implemented on a single server and that particular server may have some or all of the components described herein.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Voice over Internet Protocol (VoIP) network, a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types. The communication network 104 may comprise a number of different communication media such as coaxial cable, copper cable/wire, fiber-optic cable, antennas for transmitting/receiving wireless messages, and combinations thereof.

The guideline management system 116 may be capable of determining one or more severe weather events has occurred. Severe weather events may comprise one or more of hail, wind, hurricane, earthquake, flood, tornado, etc.

Upon the detection of a disaster and/or severe weather event, the guideline management system 116 may determine an impact of the disaster and/or event. The impact determination may comprise determining a severity of the event. The impact determination may further comprise determining a location of the event. Determining the location of the event may comprise determining an epicenter of the event. Many severe weather events have radiating degrees of damage, in which the event causes a greatest amount of damage at or near an epicenter of the event. Some events may have other zone shapes. For example, a hurricane or tornado may have an epicenter in the shape of a line tracing the path of the eye of the storm.

The guideline management system may be capable of determining one or more zones associated with a severe weather event. Each zone may have a different level of estimated damage to properties within the zones. For example, a first zone may encompass the epicenter of the severe weather event. Such a first zone may be predicted to include those properties with the greatest amount of damage. A second zone may surround the first zone and be predicted to include properties with less damage than the properties within the first zone. Additional zones may be determined by the guideline management system for each determined weather event.

In some embodiments, lines such as county lines or zip codes may be used to create the shapes of the zones. Resulting in more efficient creation of zones, but may also result in less accurate damage levels within each zone.

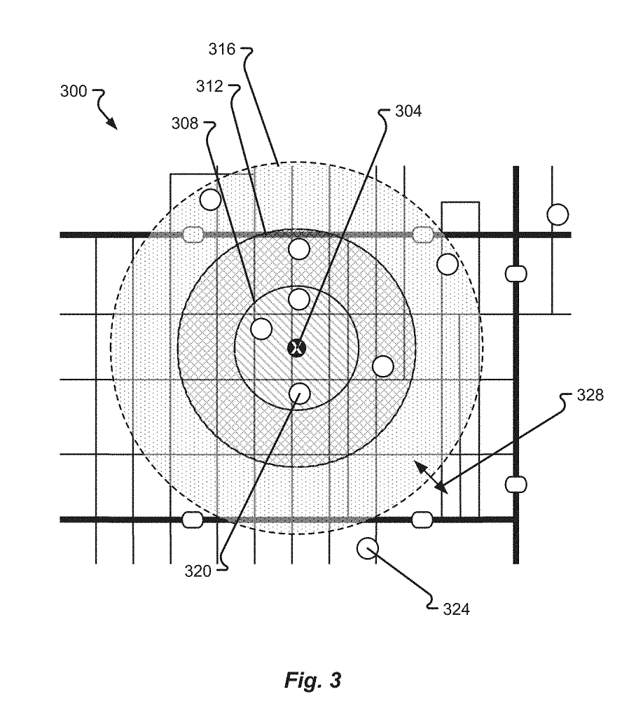

As illustrated in FIG. 3, the guideline management system may set up geo-fences or similar types of geographical boundaries to create zones. FIG. 3 illustrates a severe weather event with a single epicenter and in which damages lessens as the distance from the epicenter increases. This may be similar to events such as an earthquake.

The guideline management system, upon determining a severe weather event has occurred, may download or otherwise obtain a map 300 of the area. The map 300 of the area may further comprise one or more properties 320, 324 within the area. Each property 320, 324 within the area may be associated with a property entry within a database of the memory of the guideline management system.

The guideline management system 116 may determine an epicenter 304 of the severe weather event. Based on a determined severity of the weather event and based upon historical data and other factors, the guideline management system may create one or more zones 308, 312, 316, in outward circles from the epicenter. While the illustration of FIG. 3 shows a severe weather event with an epicenter at a single point, other severe weather events may have epicenters of various shapes. For example, a hurricane or tornado may follow a path. Zones created by the guideline management system 116 for such severe weather events may comprise shapes different from the zones 308, 312, 316 illustrated in FIG. 3.

As can be appreciated from FIG. 3, a property 324 may lie outside of any zone 308, 312, 316. Such a property 324 may be estimated by the guideline management system to have suffered little if any damage from the severe weather event. As illustrated by the arrow 328, land illustrated in the map may either be in one of the zones 308, 312, 316 or may be outside of the zones 308, 312, 316. Another property 320 may be within a particular first zone 308. The guideline management system may determine all properties, such as property 320, within the first zone 308 may be properties with the greatest amount of damage from the severe weather event as the first zone 308 is the zone containing the epicenter of the severe weather event. A second zone 312 may comprise properties with less damage than properties within the first zone 308, but greater damage than properties within the third zone 316.

Following the creation of zones, a number of aerial CAD surveys may be ordered to further survey the damaged area. Aerial CAD surveys may allow for a number of factors to be evaluated, such as roof shapes, property sizes, etc. Following the aerial CAD surveys, the guideline management system may determine one or more policies in force for each damaged property.

The guideline management system 116 may be capable of determining one or more inspectors for each property who is qualified to create a scope of repair for the property. The determination of one or more inspectors who is qualified to create a scope of repair for such a property may be made based on a number of factors, such as which zone a particular property is positioned within (or not positioned within).

The guideline management system 116 may determine which of one or more inspectors who is qualified to create a scope of repair for such a property based on a location of each inspector relative to a location of the property. Inspectors should be fairly close to the property to be qualified. By limiting inspectors to only those inspectors within a relatively close distance to the property, the guideline management system 116 may cut down on commute time for the inspectors and thus increase efficiency of the overall response to the severe weather event. Ideally, each inspector may inspect a large number of properties. As such, if an inspector can be limited to a particular area, the inspector may be more efficient.

The guideline management system 116 may determine which of one or more inspectors who is qualified to create a scope of repair for such a property based on the geographical zones overlaid on the map by the guideline management system. For example, some inspectors will not be qualified, or will not desire, to inspect properties with greater amount of damage. Alternatively, some inspectors may only be qualified or will only desire to inspect properties with a greater amount of damage.

The guideline management system 116 may determine which of one or more inspectors who is qualified to create a scope of repair for such a property based on the policies in force. Some insurance companies will restrict qualified inspectors to only those pre-approved by the insurance companies. Some municipalities, states, counties, etc. may place further restrictions on which inspectors are qualified. For example, a disaster may take place between Montana and Wyoming. Montana may require inspectors to be licensed in Montana, while Wyoming may require inspectors to be licensed in Wyoming.

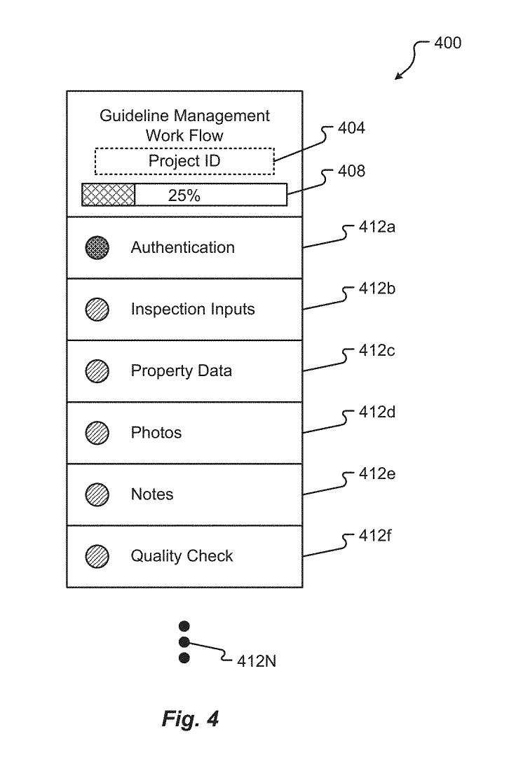

After determining one or more qualified inspectors for each property, the guideline management system may create a workflow for the generation of the scope of work as illustrated in FIG. 4. The workflow for each property may be shared with each qualifying inspector. Inspectors may correspond to qualified/trained inspectors or, in some embodiments, trusted contractors or service providers that can be quasi-trained or certified in real-time in response to a damaging event. Inspectors that are trained at the time or just after a severe weather event may become temporary inspectors that are qualified to provide inspection services within some zones, but not within other zones. For instance, such temporary inspectors may be given permissions to provide inspection services that are relied upon by an insurance carrier as long as the inspections are performed on properties 320 within a particular zone (e.g., zone 308) having a highly uniform damage profiles or predictable damage profiles.

The guideline management system 116 may be capable of generating workflows such that each inspector may follow the workflow while inspecting a damaged property. The workflow generated by the guideline management system should ensure the scope of work (and the resulting estimate) is in line with any and all policies in force for the property. A workflow may be presented to each inspector as a user interface on a communication device of the inspector as illustrated in FIG. 4.

The user interface 400 may comprise a project ID 404. The project ID 404 may be used to identify an entry in a project database of the guideline management system. The project database of the guideline management system may comprise an entry for each inspector's inspection of each property. Each entry may comprise all information needed to generate a scope of work based on the inspection performed by the inspector following the workflow. The workflows generated for a particular inspector may depend upon permissions granted to the inspector and whether or not the inspector has been temporarily granted these permissions or has been in possession of such permissions for a duration of time prior to the occurrence of the event.

The user interface 400 may comprise a workflow completion indicator 408. The workflow completion indicator 408 may start at zero when the inspector arrives at a damaged property. As the inspector follows the steps of the workflow, the workflow completion indicator 408 may approach 100%.

The user interface 400 may comprise a checklist showing the inspector which steps have been completed and which steps have yet to be performed. For example, the user interface may display a checklist with entries such as inspector authentication 412a, inspector's inspection inputs 412b, property data 412c, photos of the damaged property 412d, notes related to the damage 412e, a quality check 412f, and/or other data or tasks 412N.

Upon an inspector completing the scope of work in accordance with the provided workflow, the scope of work may be transmitted to the guideline management system. The guideline management system may be capable of generating estimates from the received scopes of work based on accurate prices of materials and labor. The guideline management system may further be capable of double-checking each received scope of repair to ensure each policy-in-force has been met.

The guideline management system may, after receiving an adequate number of scopes of repair from a number of inspectors for a particular damaged property, the guideline management system may wait for a notice of loss to be created by an insurance customer associated with the damaged property.

In some embodiments, the first notice of loss may be transmitted to the guideline management system via a network connection to a customer's communication device. For example, upon the customer realizing his/her property is damaged, the customer may open an application on his/her communication device. The customer may be presented with a customer workflow for entering an ID of the property, a customer ID, a quick description of the damage, etc.

The first notice of loss created by the customer may be associated with a damaged property. The guideline management system may then match the first notice of loss to one or more scopes of repair received associated with the damaged property. The guideline management system may double check that each inspector associated with each scope of repair for the damage property is still qualified to repair the property (based on location, policies in force, etc.).

The guideline management system may then award the job to the lowest estimate or may also consider which contractor/inspector is closest or which inspector plans to complete the job first. The guideline management system may additionally assist the insurance company in the settlement process, paying the contractor for the work. The guideline management system may further be capable of completing any requisite paperwork, such as obtaining permissions from local/state governments, obtaining signatures from all parties, etc. In some embodiments, the entire settlement process may be completed within just minutes or hours of the first notice of loss. The guideline management system may also be capable of tracking contractors work history and records and licenses, of completing exception audits, etc.

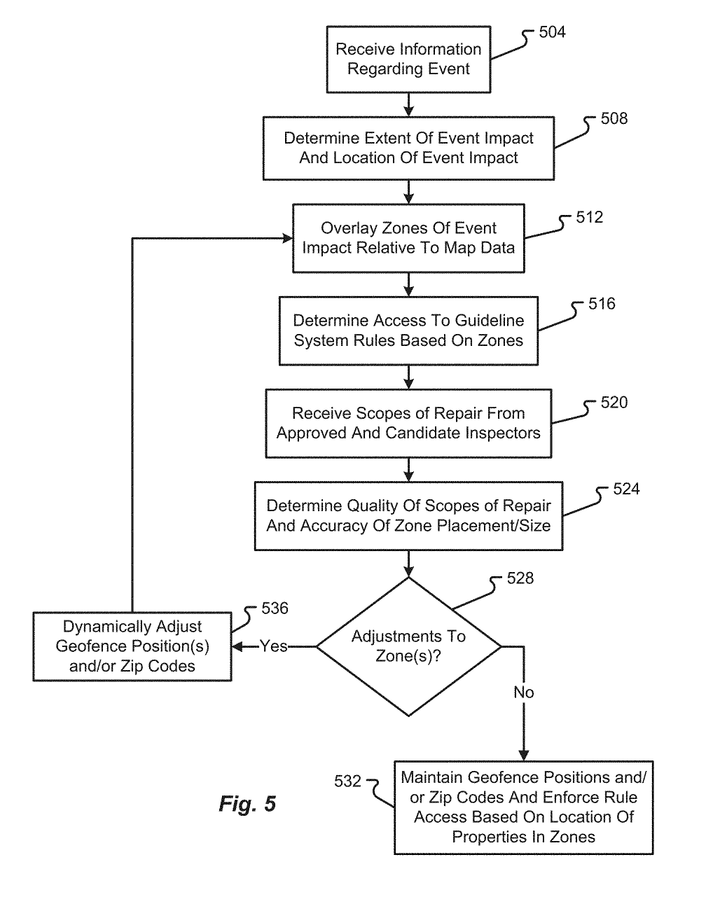

As illustrated in FIG. 5, the guideline management system as illustrated in FIGS. 1 and 2 may be capable of performing a method of adjusting damaged property geographical zones as illustrated in FIG. 3 based on received scopes of work. The method may begin at step 504 in which information regarding a severe weather event is received by the guideline management system. In some embodiments, the severe weather event information may be downloaded from a network source such as a weather service. In some embodiments, severe weather event information may be manually inputted into the guideline management system by a user of the system.

At step 508, the guideline management system may determine the location and extent of the event impact. The location and extent of the event impact may be determined based at least in part on historical data or strictly on the received information associated with the particular weather event.

The location of the event impact may comprise the epicenter of the event. The epicenter may in some events be an average or center of the total area of the event.

The extent of the event impact may be based in part on some historical data. For example, Category 5 hurricanes may be associated with a particular vastness of affected area. Such historical data may be used by the guideline management system to predict the extent of the event impact.

In some embodiments, the extent of the event impact may be based solely on weather information obtained from a number of weather sources. For example, wind speeds, or rain levels, or other weather information may be obtained from weather stations across a large area around the area of the severe weather event.

At step 512, the guideline management system may download map data for the area affected by the severe weather event. Map data may be pre-stored on memory of the guideline management system or may be obtained from one or more internet sources. Map data may include information such as zip codes, county lines, other geographical and/or municipality indicators, etc. Map data may additionally include information relating to one or more properties within the area affected by the severe weather event.

One or more of the one or more properties within the area may be related to entries within a property database of the guideline management system. For example, one or more of the properties may be insured. The guideline management system may store information related to the insurance of such properties. The guideline management system may additionally store information related to policies in force for each of the properties stored in memory. Policies in force for each property may be related to both insurance policies, as well as rules and regulations of governments associated with the property.

Based on the location and extent of the event impact, the guideline management system may overlay zones of event impact relative to the map data. The zones may be as illustrated in FIG. 3. For example, the guideline management system may determine a first geographical area surrounding the epicenter of the severe weather event in which properties contained within the first geographical area may be estimated to be most severely affected by the weather event.

The guideline management system may additionally determine one or more other geographical areas outside of the first geographical area containing properties of varying levels of estimated damage. The guideline management system may finally determine an area away from the severe weather event in which properties are estimated of having little to no damage resulting from the event.

For each geographical area determined by the guideline management system, the guideline management system may set up a particular zone. Each particular zone may contain properties for which it is estimated that a similar amount of damage has occurred as a result of the severe weather event.

At step 516, the guideline management system may determine an access level to particular guideline management system rules based on each zone.

For example, the guideline management system may determine properties within the first zone have an extremely severe level of damage. Properties within the first zone may have structural or foundational issues requiring a great amount of work and expertise on behalf of the inspector and/or contractor who will work on the property. For this reason, in such a zone less than adequate inspectors will not be allowed access to the workflows required to complete an estimate on the property. Less than adequate contractors will not be allowed to even make an estimate on the repairs for the sake of improving efficiency of the overall response to the severe weather event.

Similarly, properties in outer zones which may be estimated as to having a minor level of damage resulting from the severe weather event should in some embodiments be inspected by those inspectors lacking the expertise to work in the more severely damaged property zones. In such outer zones, the guideline management system may limit access to the requisite workflows to only those lesser-skilled inspectors and/or contractors.

In some situations, different zones may have different types of damages. For example, in the event of a hurricane, properties within the first zone may require demolition and reconstruction, while properties within the outer zones may require a great deal of clean-up and repairs. As such, the guideline management system may be capable of limiting access to the inspection of properties within a zone to only those inspectors specializing in the particular type of damage that is estimated to be affecting the properties within the zone.

At step 520, the guideline management system may receive one or more scopes of repair from inspectors. The scopes of repair may be entered into the guideline management system by one or more communication devices associated with one or more inspectors. In some embodiments, the scopes of repair may be received by the guideline management system piece by piece as the scope of repair is being generated by an inspector at the damaged property in real-time. In some embodiments, the scopes of repair may be received by the guideline management system following the completion of the inspection.

In some embodiments, the scopes of repair may come only from inspectors who have been pre-approved by the guideline management system to be qualified to prepare such a scope of work. In some embodiments, scopes of repair may be received from both approved and candidate inspectors. In the case of a scope of repair being received from a candidate inspector, the guideline management system may be capable of conducting an audit of the received scope of repair to ensure the proper guidelines and all policies in force for the particular property have been met.

At step 524, the guideline management system may determine a quality of each of the received scopes of repair and based on the determined quality of each of the received scopes of repair, the guideline management system may determine an accuracy of each of the zones of event impact overlaid relative to the map data.

In determining the quality of each of the received scopes of repair, the guideline management system may consider a number of factors. In some cases, not every entry required for the scope of repair may have been entered by an inspector—such a scope of repair may be determined to be of a lower quality. In some cases, the inspector preparing the scope of repair may be a less trustworthy source or may be less qualified to make the type of inspection required due to the type of damage.

In determining the accuracy of each of the zones of event impact overlaid relative to the map data, the guideline management system may consider the types of damage to the properties reported in the scopes of repair. For example, in the case of a flood weather event, a zone may be established in which it is estimated by the guideline management system that a low amount of flooding has occurred.

At step 528, the guideline management system may determine whether any adjustment to any of the zones of event impact needs to be made. To continue the above flood weather event example, scopes of repair received by the guideline management system may indicate the level of flooding was in actuality much greater than estimated. In such a case the guideline management system may determine the zone should be updated to reflect the actual data received from inspectors at the site of the damage.

At step 532, if no adjustment needs to be made in step 528, the guideline management system may determine the geofence positions should be maintained and the rule access should be enforced based on the location of properties in each zone. In such an event, the guideline management system may simply continue receiving scopes of work and waiting for a first notice of loss to be reported by the property owner.

At step 536, if an adjustment needs to be made in step 528, the guideline management system may dynamically adjust the position of geofences or the selection of zip codes to effect the needed adjustment. Using the received data in the scopes of work, the guideline management system may increase or decrease the size or change the shape of one or more of the zones established earlier in the method to better reflect the actually observed damage of properties within each zone.

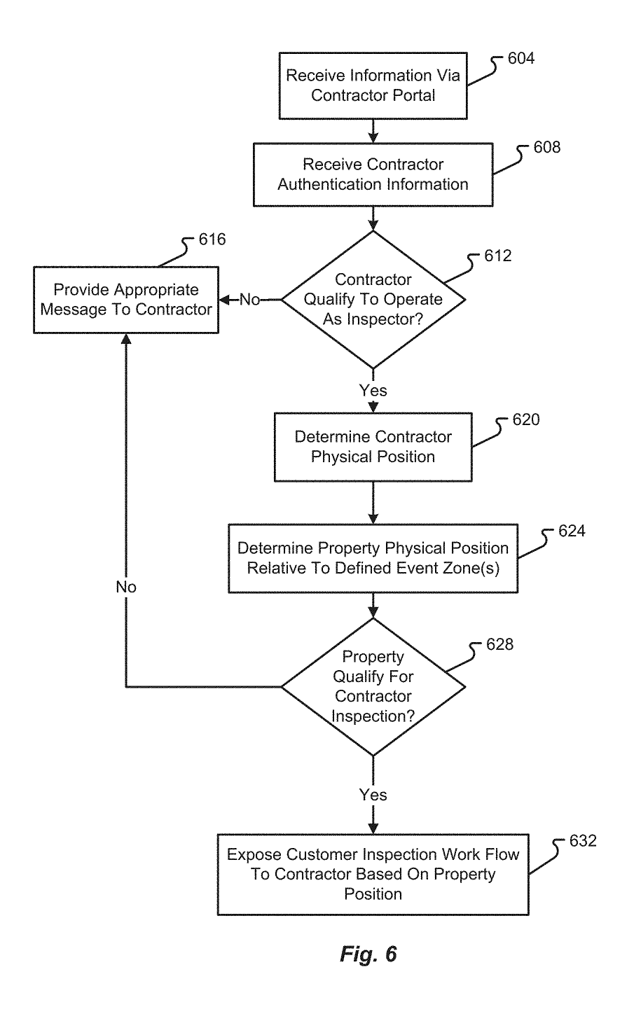

As illustrated in FIG. 6, the guideline management system as illustrated in FIGS. 1 and 2 may be capable of performing a method of providing inspection workflows as illustrated in FIG. 4 to qualified inspectors for a property. Such a method may begin at step 604, in which information may be received by the processor of the guideline management system via the network interface from communication devices operated by contractors utilizing a contractor portal application.

The information received by the guideline management system may comprise information associated with the contractor. In some embodiments, each contractor may be associated with a particular contractor ID. A contractor may simply log-in to the contractor portal application using his or her contractor identification ID and password. The guideline management system may then be capable of looking up all needed information associated with the contractor, such as all licenses associated with the contractor, any particular specialties associated with the contractor, or any other relevant information associated with the contractor.

Information received by the guideline management system may comprise information associated with a particular property. For example, a contractor may specially apply to inspect and provide a scope of repair for a particular property. In such an instance, the applying contractor may provide an identification of the property, such as an address, a photo, or other information.

In some embodiments, a contractor may provide information related to a number of properties. For example, a contractor may specifically request to be allowed to provide a scope of work for one or more properties within a particular zip code, county, or other area. Such a contractor may provide, via the contractor portal application, any such information allowing the guideline management system to identify those properties matching the contractor's request.

In some embodiments, a contractor may simply request a job without indicating any preferred or demanded property. For example, a contractor may simply be applying to survey any property affected by a severe weather event.

At step 608, the guideline management system may receive contractor authentication information via the contractor portal or from a database within memory of the guideline management system or within memory of a network location.

Contractor authentication information may comprise user ID and password, or other identifying information to ensure the actual contractor is applying. Contractor authentication information may also comprise researching the contractor by conducting a background check or by looking up the contractor's personal information in a contractor database to determine the contractor's qualifications.

At step 612, the guideline management system may determine whether the contractor is qualified to operate as an inspector properties affected by the severe weather event. The determination as to whether the contractor is qualified to operate as an inspector may comprise comparing the contractor's qualifications to one or more required qualifications for the properties affected by the weather event. In some cases, the guideline management system may determine one or more policies or regulations in force for properties affected by the weather event. Such policies or regulations may disqualify certain types of contractors from working in the area or on particular types of properties in the area.

At step 616, if the contractor is determined by the guideline management system to not qualify as an inspector, the guideline management system may provide an appropriate message to the contractor. For example, the contractor may receive a text or email stating the contractor does not qualify to work in the area. The message may additionally provide an explanation of the determining factor resulting in the disqualification. In some embodiments, the message may be presented within a user interface of the contractor portal application.

At step 620, if the contractor is determined by the guideline management system to qualify as an inspector, the guideline management system may determine a physical position of the contractor. In some embodiments, the guideline management system may request, via a user interface of the contractor portal application, the contractor to enter his or her location. In some embodiments, the guideline management system may be capable of reading a GPS location of the contractor's communication device.

At step 624, the guideline management system may determine whether the properties associated with the property information received in step 604, or whether any properties, if no property information was received in step 604, are in a close physical position relative to the contractor. For example, the guideline management system may give a higher priority to contractors closer to a particular property to increase the overall efficiency of the response to the severe weather event. The guideline management system may in some embodiments limit contractors for a particular property to those contractors who are within a certain radii of the property.

At step 628, the guideline management system may determine whether any of the one or more properties qualifies to be inspected by the contractor. The determination as to whether any of the one or more properties qualifies to be inspected by the contractor may be made based on the contractor's location in relation to each property, the contractor's qualifications in relation to the policies in force for each property, and/or any other factors.

If in step 628 the guideline management system determines no property qualifies to be inspected by the contractor, the guideline management system may simply provide an appropriate message to the contractor. For example, the contractor may receive a text or email stating the contractor does not qualify to work in the area. The message may additionally provide an explanation of the determining factor resulting in the disqualification. In some embodiments, the message may be presented within a user interface of the contractor portal application.

At step 632, if the guideline management system determined in step 628 that at least one property qualified to be inspected by the contractor, the guideline management system may transmit an inspection workflow for each of the qualifying properties to the contractor. In some embodiments, only inspection workflows for those properties close in proximity to the contractor may be sent to the contractor.

The inspection workflow may be sent via the network interface of the guideline management system to the contractor's communication device. The inspection may be displayed on the communication device in a user interface as illustrated in FIG. 4 using the contractor portal application. The workflow may enable the contractor to properly inspect the property and generate a scope of work and transmit the scope of work to the guideline management system in accordance with all policies in force for the property.

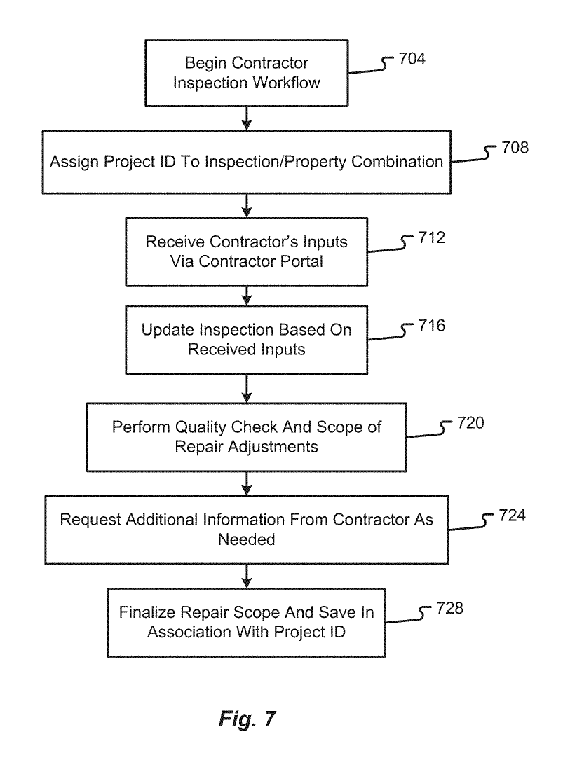

As illustrated in FIG. 7, the guideline management system as illustrated in FIGS. 1 and 2 may be capable of performing a method of receiving, verifying, and storing scopes of repair from one or more qualified contractors and/or inspectors following inspections by the qualified contractors and/or inspectors of a property. The method may begin at step 704, in which a qualified inspector may receive an inspection workflow via his or her communication device. The inspector may arrive at the location of the property associated with the inspection workflow. The inspector may being the inspection workflow at the site of the property. The guideline management system may determine the inspection workflow has begun.

At step 708, upon determining the inspection workflow has begun, the guideline management system may assign a unique project identifier (“ID”) to the inspection/property combination. By associating any and all information received from the inspector's communication device during the completion of the steps of the inspection workflow to the project ID, the guideline management system may be capable of building a scope of repair for the inspector based on the inspection data gathered by the inspector.

At step 712, the guideline management system may receive inputs from the contractor's communication device. The inputs may be made via the contractor portal. In some embodiments, an inspection may comprise the inspector creating or collecting one or more photographs. An inspection may comprise the inspector completing data fields associated with the workflow and/or any other required information build a proper scope of repair. Any data collected during the inspection may be transmitted to the guideline management system via a network connection. The guideline management system may store such received information in memory and associate such information with the unique project ID.

At step 716, the guideline management system may, with each input received from the inspector's communication device during the inspection, update a data file associated with the unique project ID based on the received inputs. As the inspection workflow is carried out by the inspector, the data file may grow in size until enough data has been collected to create an accurate scope of repair.

At step 720, the guideline management system may perform one or more quality checks and make adjustments to the scope of repair being created during the inspection of the property. Quality checks may be performed by comparing the received information to information received from other inspectors inspecting the same property. If an unusual degree of difference between the received information and the other information exists, the guideline management system may automatically make adjustments to the scope of repair being corrected or may notify the inspector of the possibility that a mistake has occurred.

In some embodiments, the guideline management system may be capable of determining if the received information is one or more of impossible, contradictory, extremely unlikely, or otherwise wrong. The guideline management may also be capable of determining whether the data input into each field during the workflow matches the type of data input which is expected for the particular field. For example, a particular field may be associated with a number. If the inspector inputs a letter or other non-number character into the particular field, the guideline management system may notify the inspector of the mistake.

At step 724, the guideline management system may receive additional information from the contractor as needed. In some embodiments, the guideline management system may determine additional information beyond what is included in the inspection workflow is required. For example, a response to a question during an inspection workflow may result in the guideline management system determining an issue may exist. The issue may need to be investigated by the performance of steps not already comprised by the inspection workflow. The guideline management system may transmit additional instructions to the inspector thus changing the workflow in order to fully investigate the new issue and to result in a proper scope of repair.

At step 728, the guideline management system may, upon the contractor reaching the end of the workflow and the guideline management system determining no additional information is required, finalize the generated repair scope and save the inspection data in associated with the project ID. Finalizing the generated repair scope may comprise formatting the received data into an easily reviewable format, such as a PDF file. Finalizing the generated repair scope may further comprise determining what if any additional information associated with the scope of repair may be determined based on the inputs of the inspector during the inspection.

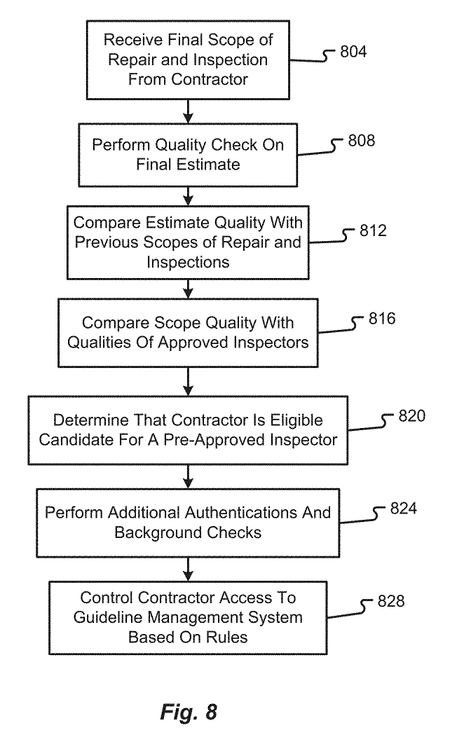

As illustrated in FIG. 8, the guideline management system as illustrated in FIGS. 1 and 2 may be capable of performing a method of determining final scopes of repair are valid and controlling access of contractors to the guideline management system based on all rules and policies in force for a particular damaged property. The method may begin at step 804, in which the guideline management system may receive a final scope of repair and inspection data from a contractor. The final scope of repair and inspection data may be received as describe in accordance with the method of FIG. 7. In some embodiments, the final scope of repair may be generated from the received inspection data.

At step 808, the guideline management system may update the scope of repair with known prices to generate an estimate. The guideline management system may then perform a quality check on the final estimate. In some embodiments, the generation of the estimate may take place after an audit is performed on the scope of repair. The guideline management system may determine known prices based on information accessed via the network interface or may be based at least in part on known prices stored in memory of the guideline management system. In some embodiments, known prices may be received from one or more contractors bidding on the job.

The quality check performed by the guideline management system may comprise determining if any particular data fields needed for an accurate scope of repair and estimate have been left blank. The quality check performed by the guideline management system may additionally or alternatively comprise determining if the known prices applied to the scope of repair are or appear accurate based on historical or recently created estimates.

At step 812, the guideline management system may compare the quality of the estimate with the quality of one or more previous scopes of repair and received inspection data. By comparing the determined quality of the estimate with the quality of other scopes of repair, the guideline management system may be capable of determining the relative quality of the estimate. In some embodiments, the guideline management system may throw out or ignore unusually low-quality scopes of repair or estimates. The guideline management system may have a lower threshold level for quality. The threshold may be adjusted based on the actual quality of the received estimates and/or scopes of repair. For example in some cases every received scope of repair and/or estimate may be of a lower quality than normal. The guideline management system may determine the threshold level for quality should be at a lower level than usually accepted.

At step 816, the guideline management system may compare the quality of the inspector associated with the estimate with a quality rating for one or more approved inspectors. By comparing the determined quality of the inspector associated with the estimate with the quality of approved inspectors associate with other scopes of repair, the guideline management system may be capable of determining the relative quality of the inspector. In some embodiments, the guideline management system may throw out or ignore scopes of repair or estimates associated with unusually low-quality inspectors. The guideline management system may have a lower threshold level for inspector quality. The threshold may be adjusted based on the actual quality of the inspectors associated with the received estimates and/or scopes of repair. For example in some cases every received scope of repair and/or estimate may be associated with an inspector of a lower quality than normal. The guideline management system may determine the threshold level for inspector quality should be at a lower level than usually accepted.

At step 820, the guideline management system may determine that the contractor associated with the estimate is an eligible candidate to be a pre-approved inspector. In some embodiments, the determination that the contractor associated with the estimate is an eligible candidate to be a pre-approved inspector may be based on the determined relative quality of both the contractor and the estimate associated with the contractor.

At step 824, the guideline management system may perform one or more additional authentications and/or background checks to ensure that the contractor associated with the estimate is an approved inspector. The additional authentications and/or background checks may be performed by the guideline management system using data from one or more network locations such as background check services accessible via the Internet. In some embodiments, additional authentications and/or background checks may be requested from other services by the guideline management system. In some embodiments, the additional authentications and/or background checks may comprise determining if the contractor has all requisite licenses and whether the contractor's licenses are up-to-date and currently valid. The guideline management may perform other due diligence as required to be up to code based on any and all policies in force for the particular property.

At step 828, the guideline management system may, upon determining the contractor associated with the estimate is an approved inspector, control the access to the guideline management system to other contractors based on one or more rules associated with the policies in force for the property. For example, after an approved contractor has made a final scope of repair using an inspection workflow, the guideline management system may determine few other final scopes of repair may be desired for the particular property. The guideline management system may limit future inspections of the particular property to only inspectors of highest quality or with potentially lower estimates relative to the estimate generated from the inspection information received from the approved contractor.

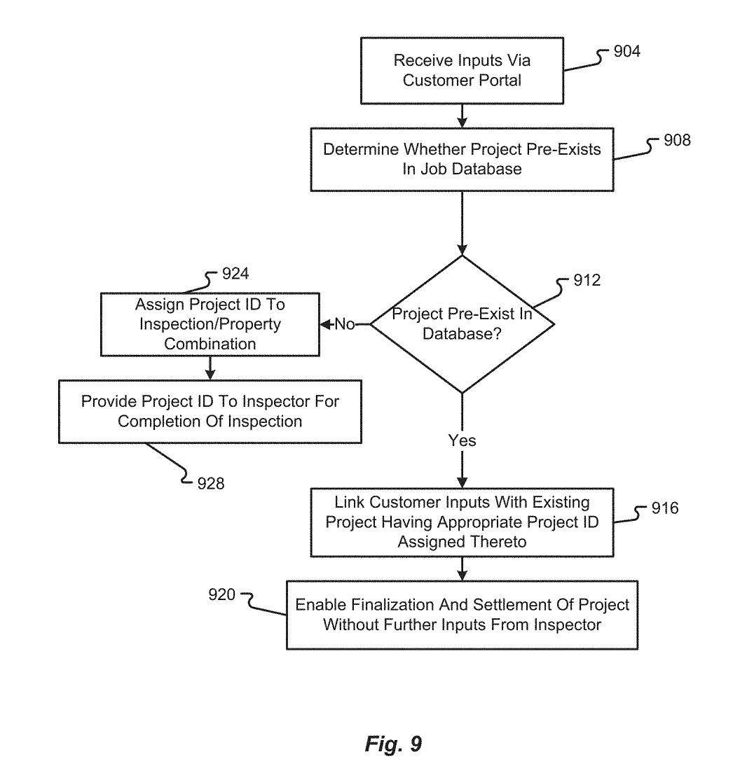

As illustrated in FIG. 9, the guideline management system as illustrated in FIGS. 1 and 2 may be capable of performing a method of automatically settling a project following a first notice of loss. The method may begin at step 904, in which a customer associated with a damaged property may report the damage to the guideline management system via a customer portal using a customer communication device. The report may comprise a first-notice-of-loss. In some embodiments, the information received from the customer may simply comprise an address of the damaged property. In some embodiments, the information received from the customer may comprise a description of the damage to the property.

At step 908, the guideline management system may compare the received customer data with information stored in memory of the guideline management system to determine whether a project ID already exists in a job database in memory of the guideline management system. For example, each project ID may be associated with a particular property identified by an address. The guideline management system may be capable of matching the property associated with the received customer data with one or more project IDs to verify the property has already been inspected or is otherwise known by the guideline management system. At step 912, the guideline management system may make the determination as to whether the project ID already exists in the job database.

At step 916, if the guideline management system determines the project ID is pre-existing in the database, the guideline management system may link the received customer information with the existing project assigned to the appropriate project ID. The guideline management system at this point may have multiple scopes of repair and or estimates generated for the property and having received a first notice of loss from the property owner via the customer portal the guideline management system may determine the job may be rewarded and the project may be settled.

Following step 916, at step 920, the guideline management system may enable the finalization and settlement of the project without requiring any further input from any inspector. The finalization and settlement of the project may comprise determining a lowest priced estimate and may comprise factoring in the determined quality of each estimate to determine the best current estimate. In some embodiments, the lowest priced estimate may be chosen, while in other embodiments, an algorithm balancing high-quality and low-price may be used to select an optimal estimate.

After selecting the optimal estimate, the guideline management system may settle the project by awarding the job to the contractor associated with the optimal estimate. The contractor and property owner may then each be notified of the settlement and the contractor may be capable of beginning the work or may be provided a chance to accept or decline the work.

At step 924, if the guideline management system does not determine, in step 912, that the project ID is pre-existing in the database, the guideline management system may assign a new project ID to the received customer data, creating a new inspection/property combination.

At step 928, after creating the new inspection/property combination, the guideline management system may provide the new project ID to one or more inspectors for completion of an inspection of the property to advance the process leading to awarding the job to an approved contractor and settling the project.

As can be seen from the above description, the systems and methods disclosed herein are useful for automating the process of selecting a contractor to complete a job. Specific details were given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. Persons of ordinary skill in the art will also understand that various embodiments described above may be used in combination with each other without departing from the scope of the present disclosure.

While illustrative embodiments of the disclosure have been described in detail herein, it is to be understood that the inventive concepts may be otherwise variously embodied and employed, and that the appended claims are intended to be construed to include such variations, except as limited by the prior art.

Moreover, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the description.

What is claimed is:

1. A method comprising:
Receiving, by a processor via a network connection, information associated with a severe weather event;
determining, by the processor, a geographical extent of impact of the event;
determining, by the processor, a location of the impact of the event, wherein the location of the impact of the event is associated with a geographical area;
based on the determination of the extent of impact and the determination of the location of the impact, determining, by the processor, one or more geographical zones associated with the event, wherein each of the one or more geographical zones is associated with a different portion of the geographical area;
for each of the one or more geographical zones associated with the event, determining, by the processor, an access level to guideline system rules;
receiving, by the processor via the network connection, information associated with one or more contractors;
determining, by the processor, a quality rating for each of the one or more contractors;
based on the determined quality rating for each of the one or more contractors, determining that a first contractor is qualified to operate as a temporary inspector;
determining a geographical location of the contractor;
determining a location of each of one or more physical properties in the geographical area, wherein the location is determined relative to one or more geographical zones associated with the event;
based on the determined location of each of one or more physical properties and the determined access level for geographical zone relative to the location, determining a first physical property of the one or more physical properties qualifies for contractor inspection; and
transmitting, by the processor via the network connection, an inspection work flow associated with the first physical property to a user device associated with the contractor.

2. The method of claim 1, wherein one or more scopes of repair are received from one of one or more contractors.

3. The method of claim 2, wherein the one or more contractors comprise one or more of approved inspectors and candidate inspectors.

4. The method of claim 1, further comprising determining an accuracy of the determined one or more geographical zones associated with the event based on one or more scopes of repair.

5. The method of claim 4, further comprising, based on the determined accuracy of the determined one or more geographical zones associated with the event, determining no adjustments to the one or more geographical zones are required.

6. The method of claim 1, further comprising, based on the determination that no adjustments to the one or more geographical zones are required, enforcing the determined access level to guideline system rules based on a location of one or more properties in each of the one or more geographical zones.

7. The method of claim 1, further comprising receiving one or more scopes of repair.

8. The method of claim 7, further comprising receiving contractor authentication information associated with the received contractor information.

9. The method of claim 8, further comprising, based on the received contractor authentication information, determine the contractor is qualified to operate as an inspector.

10. A system comprising:
a processor and
a computer-readable storage medium storing computer-readable instructions, which when executed by the processor, cause the processor to perform:
receiving by the processor via a network connection information associated with an event;
determining, by the processor, an extent of impact of the event;
determining, by the processor, a location of the impact of the event, wherein the location of the impact of the event is associated with a geographical area;
based on the determination of the extent of impact and the determination of the location of the impact, determining, by the processor, one or more geographical zones associated with the event, wherein each of the one or more geographical zones is associated with a different section portion of the geographical area;
for each of the one or more geographical zones associated with the event, determining, by the processor, an access level to guideline system rules;
receiving, by the processor via the network connection, information associated with one or more contractors;
determining, by the processor, a quality rating for each of the one or more contractors;
based on the determined quality rating for each of the one or more contractors, determining that a first contractor is qualified to operate as an inspector;
determining a geographical location of the contractor;
determining a location of each of one or more physical properties in the geographical area, wherein the location is determined relative to one or more geographical zones associated with the event;
based on the determined location of each of one or more physical properties and the determined access level for geographical zone relative to the location, determining a first physical property of the one or more physical properties qualifies for contractor inspection; and
transmitting, by the processor via the network connection, an inspection work flow associated with the first physical property to a user device associated with the contractor.

11. The system of claim 10, wherein one or more scopes of repair are received from one of one or more contractors.

12. The system of claim 11, wherein the one or more contractors comprise one or more of approved inspectors and candidate inspectors.

13. The system of claim 10, wherein the computer-readable instructions, which when executed by the processor, further cause the processor to perform determining an accuracy of the determined one or more geographical zones associated with the event based on one or more scopes of repair.

14. The system of claim 13, wherein the computer-readable instructions, which when executed by the processor, further cause the processor to perform, based on the determined accuracy of the determined one or more geographical zones associated with the event, determining no adjustments to the one or more geographical zones are required.

15. The system of claim 10, wherein the computer-readable instructions, which when executed by the processor, further cause the processor to perform, based on the determination that no adjustments to the one or more geographical zones are required, enforcing the determined access level to guideline system rules based on a location of one or more properties in each of the one or more geographical zones.

16. A computer program product comprising:
a non-transitory computer readable storage medium having computer-readable program code embodied therewith, the computer-readable program code configured when executed by a processor to:
receive by the processor via a network connection information associated with an event;
determine, by the processor, an extent of impact of the event;
determine, by the processor, a location of the impact of the event, wherein the location of the impact of the event is associated with a geographical area;
based on the determination of the extent of impact and the determination of the location of the impact, determine, by the processor, one or more geographical zones associated with the event, wherein each of the one or more geographical zones is associated with a different section portion of the geographical area;
for each of the one or more geographical zones associated with the event, determine, by the processor, an access level to guideline system rules;
receive, by the processor via the network connection, information associated with one or more contractors;
determine, by the processor, a quality rating for each of the one or more contractors;
based on the determined quality rating for each of the one or more contractors, determine that a first contractor is qualified to operate as an inspector;
determine a geographical location of the contractor;
determine a location of each of one or more physical properties in the geographical area, wherein the location is determined relative to one or more geographical zones associated with the event;
based on the determined location of each of one or more physical properties and the determined access level for geographical zone relative to the location, determine a first physical property of the one or more physical properties qualifies for contractor inspection; and
transmit, by the processor via the network connection, an inspection work flow associated with the first physical property to a user device associated with the contractor.

17. The computer program product of claim 16, wherein one or more scopes of repair are received from one of one or more contractors.

18. The computer program product of claim 17, wherein the one or more contractors comprise one or more of approved inspectors and candidate inspectors.

19. The computer program product of claim 16, wherein the computer-readable program code is further configured when executed by the processor to determine an accuracy of the determined one or more geographical zones associated with the event based on one or more scopes of repair.

20. The computer program product of claim 19, wherein the computer-readable program code is further configured when executed by the processor to, based on the determined accuracy of the determined one or more geographical zones associated with the event, determining no adjustments to the one or more geographical zones are required.
